(19) United States
(12) Patent Application Publication
(10) Pub. No.: US 2026/0181452 A1
(43) Pub. Date: Jun. 25, 2026

(54) METHOD AND APPARATUS FOR NTN NEIGHBOUR CELL MEASUREMENT IN WIRELESS COMMUNICATION SYSTEM

(71) Applicant: Samsung Electronics Co., Ltd., Suwon-si, Gyeonggi-do (KR)

(72) Inventors: Jonas SEDIN, Staines (GB); Chadi KHIRALLAH, Staines (GB)

(21) Appl. No.: 19/129,547

(22) PCT Filed: Jan. 31, 2024
(86) PCT No.: PCT/KR2024/001473

§ 371 Date: May 13, 2025

(30) Foreign Application Priority Data
Feb. 8, 2023 (GB) 2301788.2
Jan. 5, 2024 (GB) 2400176.0

(51) Int. Cl. H04W 24/10; H04W 64/00; H04W 84/06

(52) U.S. Cl. CPC H04W 24/10; H04W 64/00; H04W 84/06

(57) ABSTRACT

The disclosure relates to a 5G or 6G communication system for supporting a higher data transmission rate. Disclosed is a method of operating a User Equipment, UE, where the UE is communicatively connectable to a Non-Terrestrial Network, NTN, the method comprising the step of in response to a determination of a predetermined condition, the UE determines whether to acquire or not to acquire System Information from a System Information Block, SIB.

### TECHNICAL FIELD

The present disclosure relates to a wireless communication system (or, a mobile communication system). More specifically, the disclosure provides a method and an apparatus for non-terrestrial network (NTN) cell measurement in the wireless communication system (or, the mobile communication system).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

There are needs to enhance performing a neighbour cell measurement for NTN access.

### Solution to Problem

According to an aspect of the present disclosure, a method performed by a terminal is provided. The method comprises: receiving, from a base station, at least one of time information on when a non-terrestrial network (NTN) cell is going to stop serving an area, or threshold information on a distance from a reference location; and identifying whether to perform a measurement, based on at least one of the time information or the distance threshold information.

According to an aspect of the present disclosure, a terminal is provided. The terminal comprises: a transceiver; and a controller coupled with the transceiver and configured to: receive, from a base station, at least one of time information on when a non-terrestrial network (NTN) cell is going to stop serving an area, or threshold information on a distance from a reference location, and identify whether to perform a measurement, based on at least one of the time information or the distance threshold information.

### Advantageous Effects of Invention

According to various embodiments of the disclosure, neighbour cell measurement procedure for NTN access can be efficiently enhanced.

### BRIEF DESCRIPTION OF DRAWINGS

FIG. 1 shows an example of a configuration of an NTN network according to an embodiment of the disclosure.

FIG. 2 shows an example of a radio link failure (RLF) procedure according to an embodiment of the disclosure.

FIG. 3 shows an example of global navigation satellite system (GNSS) validity operation according to an embodiment of the disclosure.

FIG. 4 shows an example of neighbour cell measurement procedure according to an embodiment of the disclosure.

FIG. 5 shows another example of neighbour cell measurement procedure according to an embodiment of the disclosure.

FIG. 6 shows another example of neighbour cell measurement procedure according to an embodiment of the disclosure.

FIG. 7 is a block diagram showing a structure of a terminal according to an embodiment of the disclosure.

FIG. 8 is a block diagram showing a structure of a base station according to an embodiment of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, embodiments of the disclosure will be described in detail with reference to the accompanying drawings. It should be noted that the same reference numerals in different drawings will be used to refer to the same elements already described.

The present invention relates to the provision of Non-Terrestrial Network (NTN) access for E-UTRAN IoT devices (NB-IoT and LTE-M/eMTC). It further relates to specifying adaptation to allow New Radio (NR) to function over NTN. Non-Terrestrial Network access may be through Lower Earth Orbit (LEO), Medium Earth Orbit (MEO) and Geostationary Orbit (GEO), as well as through High-Altitude Platform Systems (HAPS).

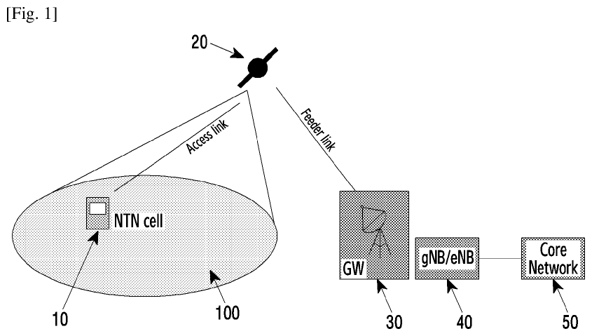

FIG. 1 shows a generic configuration of part of a Non-Terrestrial Network. It includes a User Equipment (UE) 10 operable within a NTN cell 100. The cell 100 is facilitated by the satellite 20, which is operable to communicate with the UE 10 and a gateway 30. The gateway 300 is then further coupled to a base station (gNB or eNB) 40, which is then coupled to a Core network 50.

The invention has several aspects to it, which are set out below.

Narrowband Internet of Things (NB-IoT) is a 3GPP-defined network based on 4G E-UTRAN that supports ultra-low complexity devices with very narrow bandwidth that was introduced in 3GPP Release 13. The use case of NB-IoT is to serve massive IoT application, where requirements, for instance, are to support enhanced coverage, power-efficient operation and a massive number of devices. Some of the features introduced are: support for enhanced coverage through low bandwidth and extreme amounts of repetitions; and power-efficient operation by allowing the User Equipment (UE) to sleep for very long times, relaxed requirements and more efficient signaling to establish with a cell.

Further, prior to 3GPP Release 17, neighbour cell measurements for a NB-IoT UE was not specified. This was not introduced for NB-IoT as it was imagined that an NB-IoT UE should be simple and stationary and only connect to an eNodeB (eNB) to deliver short packets, and as a result connected mode handovers were never defined. This meant that an NB-IoT UE would measure cells and select a suitable one when in idle mode and then stay with that cell until moving back to idle mode. If a Radio Link Failure (RLF) is triggered due to mobility, then an NB-IoT UE would perform cell selection and then connect to a suitable cell. Thus NB-IoT mobility in connected mode would rely on triggering RLF and then measuring other cells.

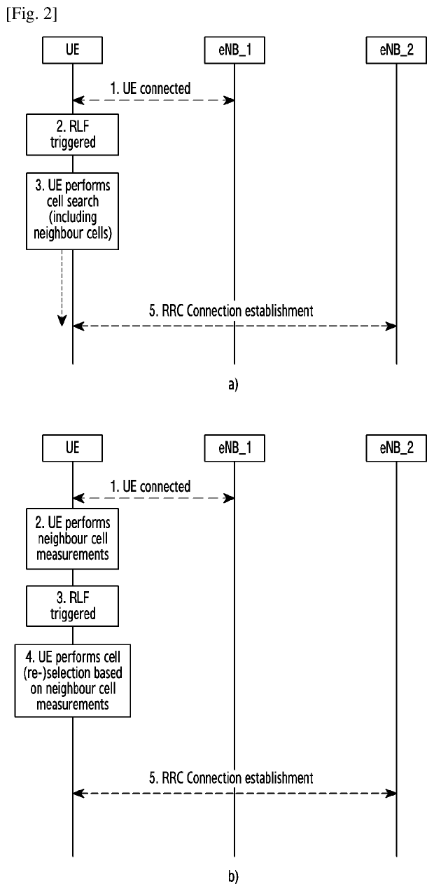

In 3GPP Release 17, enhancements were introduced to improve NB-IoT mobility. The enhancements were based on targeting the NB-IoT RLF-like mobility by introducing the ability of NB-IoT UE to measure neighbouring cells while in connected mode. If RLF is triggered, then the NB-IoT UE would already have performed the measurements needed in order to select a suitable cell. This procedure compared to the previous situation is shown in FIG. 2, where a) shows the RLF procedure according to Release 17 and b) shows the NB-IoT enhancements. In essence, b) includes an extra step of the UE performing measurements of neighbouring cells so that it can be prepared in the event of RLF.

The solutions are specified by having neighbour cell measurement criteria that is broadcasted for the UE to apply. In release 1,7 the criteria to perform neighbour cell measurements is that the relaxed monitoring criteria, is fulfilled.

The specifications in [TSTS36.331, V17.3.0] are as following table 1:

```
TABLE 1
  ------------------------------ TS36.331 V17.3.0 ------------------------------
  5.5.8 Measurements in NB-IoT
  Upon transition to RRC_CONNECTED mode, the UE shall:
```

| 1> | if neighCellMeasCriteria is present in SystemInformationBlockType3-NB: | |
|---|---|---|
| | 2> | set NRSRP_{Ref} to the latest result of the serving cell measurement as used for cell |

selection/reselection evaluation;

| | |
|---|---|
| 2> | if the relaxed monitoring criterion defined in TS 36.304 [4] was not fulfilled: |

| | |
|---|---|
| 3> | start T326 with the value t-MeasureDeltaP; |

While in RRC_CONNECTED mode, after performing a measurement, the UE shall:

| | |
|---|---|
| 1> | in the following use the NRSRP measurement for the measured carrier and nrs- |

PowerOffsetNonAnchor corresponding to the measured carrier;

| 1> | if neighCellMeasCriteria is present in SystemInformationBlockType3-NB: | |
|---|---|---|
| | 2> | if (NRSRP_{Ref} − (NRSRP − nrs-PowerOffsetNonAnchor)) > s-MeasureDeltaP: |

| | |
|---|---|
| 3> | set NRSRP_{Ref} = (NRSRP − nrs-PowerOffsetNonAnchor); |
| 3> | start or restart T326 with the value t-MeasureDeltaP; |

| 1> | if neighCellMeasCriteria is not present in SystemInformationBlockType3-NB; or | |
|---|---|---|
| 1> | if T326 is running: | |
| | 2> | if (NRSRP − nrs-PowerOffsetNonAnchor) < s-MeasureIntra, perform intra-frequency |

measurements as defined in TS 36.133 [16];

| | |
|---|---|
| 2> | if (NRSRP − nrs-PowerOffsetNonAnchor) < s-MeasureInter, perform inter-frequency |

```
  measurements as defined in TS 36.133 [16].
  ------------------------------ TS36.331 V17.3.0 ------------------------------
```

Where the related information elements are as following table 2:

TABLE 2
------------------------------ TS36.331 V17.3.0 ------------------------------
- SystemInformationBlockType3-NB
The IE SystemInformationBlockType3-NB contains cell re-selection information common for intra-
frequency, and inter-frequency cell re-selection as well as intra-frequency cell re-selection information other
than neighbouring cell related.
SystemInformationBlockType3-NB information element
-- ASN1START

| | |
|---|---|
| SystemInformationBlockType3-NB-r13 ::= | SEQUENCE { |
| cellReselectionInfoCommon-r13 | SEQUENCE { |
| q-Hyst-r13 | ENUMERATED { |
| | dB0, dB1, dB2, dB3, dB4, dB5, dB6, dB8, dB10, |
| | dB12, dB14, dB16, dB18, dB20, dB22, dB24 |
| | } |

},

| | |
|---|---|
| cellReselectionServingFreqInfo-r13 | SEQUENCE { |
| s-NonIntraSearch-r13 | ReselectionThreshold |

},

| intraFreqCellReselectionInfo-r13 | SEQUENCE { | |
|---|---|---|
| q-RxLevMin-r13 | Q-RxLevMin, | |
| q-QualMin-r13 | Q-QualMin-r9 | OPTIONAL, -- Need OP |
| p-Max-r13 | P-Max | OPTIONAL, -- Need OP |

| | |
|---|---|
| s-IntraSearchP-r13 | ReselectionThreshold, |
| t-Reselection-r13 | T-Reselection-NB-r13 |

},

| | | |
|---|---|---|
| freqBandInfo-r13 | NS-PmaxList-NB-r13 | OPTIONAL, |

-- Need OR

| multiBandInfoList-r13 | SEQUENCE (SIZE (1..maxMultiBands)) OF | |
|---|---|---|
| | NS-PmaxList-NB-r13 | OPTIONAL, |

-- Need OR

| | | |
|---|---|---|
| lateNonCriticalExtension | OCTET STRING | OPTIONAL, |

...,

| | |
|---|---|
| [[ intraFreqCellReselectionInfo-v1350 | IntraFreqCellReselectionInfo-NB-v1350 OPTIONAL |

```
  -- Cond Qrxlevmin
  ]],
```

| | |
|---|---|
| [[ intraFreqCellReselectionInfo-v1360 | IntraFreqCellReselectionInfo-NB-v1360 OPTIONAL |

```
  -- Need OR
  ]],
```

| | |
|---|---|
| [[ intraFreqCellReselectionInfo-v1430 | IntraFreqCellReselectionInfo-NB-v1430 OPTIONAL |

```
  -- Need OR
  ]],
```

| | |
|---|---|
| [[ cellReselectionInfoCommon-v1450 | CellReselectionInfoCommon-NB-v1450 OPTIONAL |

```
  -- Need OR
  ]],
```

| | | |
|---|---|---|
| [[ nsss-RRM-Config-r15 | NSSS-RRM-Config-NB-r15 | OPTIONAL, -- Need OR |
| npbch-RRM-Config-r15 | ENUMERATED {enabled} | OPTIONAL -- Need OR |

]],

| | | |
|---|---|---|
| [[ connMeasConfig-r17 | ConnMeasConfig-NB-r17 | OPTIONAL, -- Need OR |
| t-Service-r17 | TimeOffsetUTC-r17 | OPTIONAL |

```
  -- Need OR
  ]]
}
```

| | |
|---|---|
| IntraFreqCellReselectionInfo-NB-v1350 ::= | SEQUENCE { |
| delta-RxLevMin-v1350 | INTEGER (−8..−1) |

}

| | |
|---|---|
| IntraFreqCellReselectionInfo-NB-v1360 ::= | SEQUENCE { |
| s-IntraSearchP-v1360 | ReselectionThreshold-NB-v1360 |

}

| IntraFreqCellReselectionInfo-NB-v1430 ::= | SEQUENCE { | |
|---|---|---|
| powerClass14dBm-Offset-r14 | ENUMERATED {dB−6, dB−3, dB3, dB6, dB9, dB12} | OPTIONAL, -- |

Need OP

| | |
|---|---|
| ce-AuthorisationOffset-r14 | ENUMERATED {dB5, dB10, dB15, dB20, dB25, dB30, dB35} |

OPTIONAL -- Need OP
}

| | |
|---|---|
| CellReselectionInfoCommon-NB-v1450 ::= | SEQUENCE { |
| s-SearchDeltaP-r14 | ENUMERATED {dB6, dB9, dB12, dB15} |

}
ConnMeasConfig-NB-r17 ::= SEQUENCE {

| | |
|---|---|
| s-MeasureIntra-r17 | NRSRP-Range-NB-r14, |
| s-MeasureInter-r17 | NRSRP-Range-NB-r14 OPTIONAL, -- Need OP |
| neighCellMeasCriteria-r17 | SEQUENCE { |
| s-MeasureDeltaP-r17 | ENUMERATED {dB6, dB9, dB12, dB15}, |
| t-MeasureDeltaP-r17 | ENUMERATED {s15, s30, s45, s60} |

} OPTIONAL -- Need OR
}
-- ASN1STOP
SystemInformationBlockType3-NB field descriptions
ce-AuthorisationOffset
Parameter “Qoffset_{authorization}” in TS 36.304 [4]. Value in dB. Value dB5 corresponds to 5 dB, dB10
corresponds to 10 dB and so on.
If the field is absent, the UE applies the value of ce-authorisationOffset in
SystemInformationBlockType1-NB.
multiBandInfoList
A list of additionalPmax and additionalSpectrumEmission values as defined in TS 36.101 [42], clause
6.2.4F, applicable for the intra-frequency neighbouring NB-IoT cells if the UE selects the frequency
band from freqBandIndicator in SystemInformationBlockType1-NB.
npbch-RRM-Config
For FDD: Configuration for NPBCH-based RRM measurements. See TS 36.214 [24].
If enabled, NPBCH can be used in addition to NRS for RRM measurements for serving cell.
nsss-RRM-Config
For FDD: Configuration for NSSS-based RRM measurements for the serving cell.
powerClass14dBm-Offset
Parameter “Poffset” in TS 36.304 [4], only applicable for UE supporting powerClassNB-14dBm. Value
in dB. Value dB−6 corresponds to −6 dB, dB−3 corresponds to −3 dB and so on. If the field is absent, the
UE applies the (default) value of 0 dB for “Poffset” in TS 36.304 [4].
p-Max
Value applicable for the intra-frequency neighbouring E-UTRA cells. If absent the UE applies the
maximum power according to the UE capability.
q-Hyst
Parameter Q_{hyst} in TS 36.304 [4], Value in dB. Value dB1 corresponds to 1 dB, dB2 corresponds to 2
dB and so on.
q-QualMin
Parameter “Q_{qualmin}” in TS 36.304 [4], applicable for intra-frequency neighbour cells. If the field is not
present, the UE applies the (default) value of negative infinity for Q_{qualmin}.
q-RxLevMin, delta-RxLevMin
Parameter “Qᵣₓₗₑᵥₘᵢₙ” in TS 36.304 [4], applicable for intra-frequency neighbour cells. If delta-RxLevMin
is not included, actual value Qᵣₓₗₑᵥₘᵢₙ = q-RxLevMin * 2 [dBm]. If delta-RxLevMin is included, actual
value Qᵣₓₗₑᵥₘᵢₙ = (q-RxLevMin + delta-RxLevMin) * 2 [dBm].
s-IntraSearchP
Parameter “S_{IntraSearchP}” in TS 36.304 [4].
In case s-IntraSearchP-v1360 is included, the UE shall ignore s-IntraSearchP (i.e. without suffix).
s-MeasureDeltaP
Threshold of change in serving cell NRSRP to trigger neighbour cell measurement in
RRC_CONNECTED state.
s-MeasureInter
NRSRP threshold to trigger inter-frequency neighbour cell measurement in RRC_CONNECTED state.
If the field is absent in connMeasConfig, the UE applies the value of s-MeasureIntra.
s-MeasureIntra
NRSRP threshold to trigger intra-frequency neighbour cell measurement in RRC_CONNECTED state.
s-NonIntraSearch
Parameter “S_{nonIntraSearchP}” in TS 36.304 [4].
s-SearchDeltaP
Parameter “S_{SearchDeltaP}” in TS 36.304 [4]. This parameter is only applicable for UEs supporting relaxed
monitoring as specified in TS 36.306 [5]. Value dB6 corresponds to 6 dB, dB9 corresponds to 9 dB and
so on.
t-MeasureDeltaP
Duration after which the UE is not required to perfom neighbour cell measurement in
RRC_CONNECTED when s-MeasureDeltaP criterion is fulfilled.
t-Reselection
Parameter “Treselection_{NB-IoT}_{_{—}}_{Intra}” in TS 36.304 [4].
t-Service
Time information on when a NTN quasi-Earth fixed cell is going to stop serving the area it is currently
covering.

| Conditional presence | Explanation |
|---|---|
| Qrxlevmin | This field is optionally present, Need OR, if q-RxLevMin is set to the minimum |
| | value. Otherwise the field is not present. |

------------------------------- TS36.331 V17.3.0 -------------------------------

The relaxed monitoring criteria is that the received signal strength level is within a threshold of a reference received signal strength level. This is basically to ensure that the UE is not very mobile and not on the cell edge. This can be seen in the idle mode specifications as following table 3:

TABLE 3
------------------------------- TS36.304 V17.3.0 -------------------------------

| | |
|---|---|
| 5.2.4.12 | Relaxed monitoring |
| 5.2.4.12.0 | Relaxed monitoring measurement rules |

When the UE is required to perform intra-frequency or inter-frequency measurement according to
the measurement rules in clause 5.2.4.2 or 5.2.4.2a, the UE may choose not to perform intra-frequency or
inter-frequency measurements when:

| | |
|---|---|
| - | The relaxed monitoring criterion in clause 5.2.4.12.1 is fulfilled for a period of |

T_{SearchDeltaP}, and

| | |
|---|---|
| - | Less than 24 hours have passed since measurements for cell reselection were last |

performed, and

| | |
|---|---|
| - | The UE has performed intra-frequency or inter-frequency measurements for at least |

```
  T_{SearchDeltaP} after selecting or reselecting a new cell.
  5.2.4.12.1 Relaxed monitoring criterion
  The relaxed monitoring criterion is fulfilled when:
```

| | |
|---|---|
| - | (Srxlev_{Ref} − Srxlev) < S_{SearchDeltaP} |

Where:

| | |
|---|---|
| - | Srxlev = current Srxlev value of the serving cell (dB). |
| - | Srxlev_{Ref} = reference Srxlev value of the serving cell (dB), set as follows: |
| - | After selecting or reselecting a new cell, or |
| - | If (Srxlev − Srxlev_{Ref}) > 0, or |
| - | If the relaxed monitoring criterion has not been met for T_{SearchDeltaP}: |
| - | the UE shall set the value of Srxlev_{Ref} to the current Srxlev value of the serving cell; |
| - | T_{SearchDeltaP} = 5 minutes, or the eDRX cycle length if eDRX is configured and the eDRX cycle |

length is longer than 5 minutes.
------------------------------- TS36.304 V17.3.0 -------------------------------

### NTN System Information

As NTN has a number of NTN-specific information elements that are only required when accessing an NTN cell, and also due to the rather large information elements it was agreed that a new system information block (SIB) was needed.

In NR NTN, SIB 19 contains the required information to access an NTN cell, as in the following table 4:

TABLE 4

------------------------------- TS38.331 V17.3.0 -------------------------------
- SIB19
SIB19 contains satellite assistance information for NTN access.
SIB19 information element
-- ASN1START
-- TAG-SIB19-START
SIB19-r17 ::= SEQUENCE {

| | | |
|---|---|---|
| ntn-Config-r17 | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| distanceThresh-r17 | INTEGER(0..65525) | OPTIONAL, -- Need R |
| ntn-NeighCellConfigList-r17 | NTN-NeighCellConfigList-r17 | OPTIONAL, -- Need R |
| lateNonCriticalExtension | OCTET STRING | OPTIONAL, |

```
  ...,
  [[
```

| | | |
|---|---|---|
| ntn-NeighCellConfigListExt-v1720 | NTN-NeighCellConfigList-r17 | OPTIONAL -- Need R |

| ]] | |
|---|---|
| } | |
| NTN-NeighCellConfigList-r17 ::= | SEQUENCE (SIZE(1..maxCellNTN-r17)) OF NTN- |
| NeighCellConfig-r17 | |
| NTN-NeighCellConfig-r17 ::= | SEQUENCE { |

| | | |
|---|---|---|
| ntn-Config-r17 | NTN-Config-r17 | OPTIONAL, -- Need R |
| carrierFreq-r17 | ARFCN-ValueNR | OPTIONAL, -- Need R |
| physCellId-r17 | PhysCellId | OPTIONAL -- Need R |

}
-- TAG-SIB19-STOP
-- ASN1STOP

SIB19 field descriptions
distanceThresh
Distance from the serving cell reference location and is used in location-based measurement initiation in
RRC_IDLE and RRC_INACTIVE, as defined in TS 38.304 [20]. Each step represents 50m.
ntn-Config
Provides parameters needed for the UE to access NR via NTN access such as Ephemeris data,
common TA parameters, k_offset, validity duration for UL sync information and epoch.
ntn-NeighCellConfigList, ntn-NeighCellConfigListExt
Provides a list of NTN neighbour cells including their ntn-Config, carrier frequency and PhysCellId. This
set includes all elements of ntn-NeighCellConfigList and all elements of ntn-NeighCellConfigListExt. If
ntn-Config is absent for an entry in ntn-NeighCellConfigListExt, the ntn-Config provided in the entry at
the same position in ntn-NeighCellConfigList applies.
referenceLocation
Reference location of the serving cell provided via NTN quasi-Earth fixed system and is used in location-
based measurement initiation in RRC_IDLE and RRC_INACTIVE, as defined in TS 38.304 [20].
t-Service
Indicates the time information on when a cell provided via NTN quasi-Earth fixed system is going to stop
serving the area it is currently covering. The field indicates a time in multiples of 10 ms after 00:00:00 on
Gregorian calendar date 1 January, 1900 (midnight between Sunday, December 31, 1899 and Monday,
January 1, 1900). The exact stop time is between the time indicated by the value of this field minus 1
and the time indicated by the value of this field.
------------------------------- TS38.331 V17.3.0 -------------------------------

In IoT NTN SIB31 contains the required information to access an IoT NTN cell, as in the following table 5:

TABLE 5

| ------------------------------- TS36.331 V17.3.0 ------------------------------- | |
|---|---|
| - SystemInformationBlockType31 | |
| The IE SystemInformationBlockType31 contains satellite assistance information for the serving cell. | |
| SystemInformationBlockType31 is only signalled in a NTN cell. | |
| SystemInformationBlockType31 information element | |
| -- ASN1START | |
| SystemInformationBlockType31-r17 ::= SEQUENCE { | |
| servingSatelliteInfo-r17 | ServingSatelliteInfo-r17, |

| | | |
|---|---|---|
| lateNonCriticalExtension | OCTET STRING | OPTIONAL, |

| ... | |
|---|---|
| } | |
| ServingSatelliteInfo-r17 ::= | SEQUENCE { |
| ephemerisInfo-r17 | CHOICE { |
| stateVectors | EphemerisStateVectors-r17, |
| orbitalParameters | EphemerisOrbitalParameters-r17 |
| }, | |
| nta-CommonParameters-17 | SEQUENCE { |

| | | |
|---|---|---|
| nta-Common-r17 | INTEGER (0..8316827) | OPTIONAL, -- Need OP |
| nta-CommonDrift-r17 | INTEGER (−261935..261935) | OPTIONAL, -- Need OP |
| nta-CommonDriftVariation-r17 | INTEGER (0..29479) | OPTIONAL -- Need OP |

| }, | |
|---|---|
| ul-SyncValidityDuration-r17 | ENUMERATED {s5, s10, s15, s20, s25, s30, s35, s40, |
| | s45, s50, s55, s60, s120, s180, s240, s900}, |
| epochTime-r17 | SEQUENCE { |
| startSFN-r17 | INTEGER (0..1023), |
| startSubFrame-r17 | INTEGER (0..9) |

| | |
|---|---|
| } | OPTIONAL, -- Need OP |

| | |
|---|---|
| k-Offset-r17 | INTEGER (0..1023), |

| | | |
|---|---|---|
| k-Mac-r17 | INTEGER (1..512) | OPTIONAL, -- Need OP |

...
}
-- ASN1STOP

SystemInformationBlockType31 field descriptions
epochTime
Epoch time of the satellite ephemeris data and common TA parameters, see TS 36.213 [23]. The
reference point for epoch time of the serving satellite ephemeris and Common TA parameters is the
uplink time synchronization reference point.
epochTime is the starting time of a DL subframe indicated by startSFN and startSubframe. For serving
cell, the startSFN indicates the current SFN or the next upcoming SFN after the frame where the
message indicating the epochTime is received.
If the field is absent, the UE uses the starting time of the DL subframe corresponding to the end of the SI
window during which the SI message carrying SIB31 is transmitted.
E-UTRAN always includes epochTime when SystemInformationBlockType31 is provided through
dedicated signalling.
In case of handover or conditional handover, this field is based on the timing of the target cell, i.e. the
startSFN and startSubFrame number indicated in this field refers to the SFN and sub-frame of the target
cell, and UE considers the target cell epoch time (indicated by the startSFN and startSubFrame in this
field) to be the frame nearest to the frame where RRCConnectionReconfiguration message is received.
k-Mac
Scheduling offset used when downlink and uplink frame timing are not aligned at the eNB, see TS
36.213 [23]. Unit in ms.
If the field if absent, the UE uses the (default) value of 0.
k-Offset
Scheduling offset used in the timing relationships in NTN, see TS 36.213 [23]. Unit in ms.
nta-Common
Network-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDrift
Drift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariation
Drift rate variation of the common TA, see TS 36.213 [23]. Unit of μs/s².
Step of 0.2 × 10⁻⁴ μs/s². Actual value = field value * 0.2 × 10⁻⁴.
If the field is absent, the UE uses the (default) value of 0.
orbitalParameters
Instantaneous values of the satellite orbital parameters. The signalled values are only valid for the
duration as defined by ul-SyncValidityDuration and epochTime.
stateVectors
Instantaneous values of the satellite state vectors. The signalled values are only valid for the duration as
defined by ul-SyncValidityDuration and epochTime.
ul-SyncValidityDuration
Validity duration of the satellite ephemeris data and common TA parameters, i.e. maximum time duration
(from epochTime) during which the UE can apply the satellite ephemeris without acquiring new satellite
ephemeris, see TS 36.213 [23]. Unit in second.
Value s5 corresponds to 5 seconds, value s10 corresponds to 10 seconds and so on.
------------------------------- TS36.331 V17.3.0 -------------------------------

The system information contains the following table 6:

TABLE 6

| | |
|---|---|
| - | Serving cell Ephemeris elements - which allows UE to calculate the satellite position for |

doppler and time pre-compensation. This can be of two formats:

| | |
|---|---|
| ∘ | PVT format - which describes a (X,Y,Z) position as well as a speed vector (vX, vY, vZ) |
| ∘ | Orbital parameters - this describes the orbital movements of the satellite which is then |

used to infer the satellite position

| | |
|---|---|
| - | TA common parameters - this provides the common timing advance parameters which is |

introduced to compensate for the feeder link delays. The signaling consists of (in total taking up 57 bits)

| | |
|---|---|
| ∘ | Absolute TA common, taking up 23 bits |
| ∘ | Drift of the TA common - how the TA common drifts, i.e the first derivative, taking up 19 |

bits

| | |
|---|---|
| ∘ | Variation of the TA common - how the TA common varies, i.e the second derivative of |

the TA common, taking up 15 bits

| | |
|---|---|
| - | Synchronization validity duration - used to define how long the ephemeris and TA common is |

valid

| - | Epoch time - when the synchronization validity duration should start | |
|---|---|---|
| - | K-Offset - scheduling offset for timing relationship in NTN | |
| - | K-Mac - Scheduling offset used when the downlink and uplink frame timing is not aligned | |
| - | NR NTN specific information also include (as part of TS38.331): | |
| | ∘ | T-Service (signaled in SIB3 in IoT NTN) |
| | ∘ | Reference location and distance threshold - used for location-based measurement |

initiation in RRC IDLE and RRC Connected mode

| | |
|---|---|
| ∘ | Neighbour cell ephemeris |
| | ▪ This is used for idle mode measurements |

### NTN System Information Acquisition

As the ephemeris constantly changes due to the movement of the NTN payload, there is a need to make sure that the UE is correctly synchronized. Thus, whenever UE is connected to an eNB, the UE needs to read the system information. There is furthermore a timer (T317) associated with the ephemeris element that is started every time SIB31 is read. At expiry of T317, the UE is no longer considered synchronized and it will have to re-acquire SIB31 in order to stay synchronized.

In NR NTN, the UE shall ensure that it has a recent ephemeris (SIB19 in NR) by reading the SIB in time by UE implementation. In IoT NTN, since an IoT UE (LTE-M and NB-IoT UE) is not expected to be able to acquire system information in connected mode, the UE tunes away and is likely unreachable while reading SIB31. If the IoT NTN UE is unable to read the SIB31 within a timer (T318) with a configured duration, the UE performs RLF similar to other cases where Radio Link Failure (RLF) is performed.

### Global Navigation Satellite System (GNSS) Measurements in IoT NTN

Both IoT NTN and NR NTN are heavily reliant on GNSS in order to synchronize in frequency and in time, as well as to determine correct configuration and whether the UE is allowed to operate in the cell or not. However, due to the nature of how GNSS is usually in a separate part of the device and that GNSS operation is not standardized, it is not specified when a UE shall perform GNSS measurement in the current specification. It is, rather, specified as a requirement that the UE shall have a recent and precise enough GNSS position. For instance, the UE is required to have determined its own position to be used for time and frequency-synchronization and in IoT NTN the UE is required to report its GNSS validity duration in certain RRC messages. Furthermore, if the GNSS is deemed to be invalid and the UE is in connected mode, the UE shall move to idle mode.

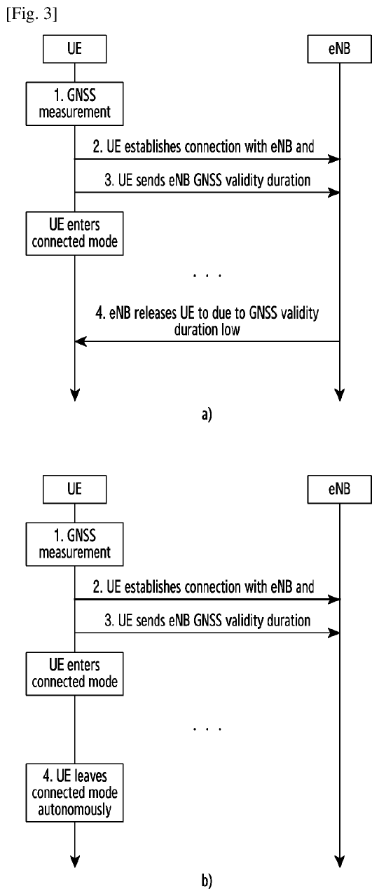

This operation can be seen in FIG. 3, (a) where the UE is released (i.e. moved to RRC Idle mode) by the eNB. In FIG. 3 (b), the UE releases itself, as in the following table 7.

TABLE 7
------------------------------- TS36.331 V17.3.0 -------------------------------

| | |
|---|---|
| 5.3.3.21 | UE actions upon indication of out-of-date GNSS position |

Upon indication that the GNSS position has become out-of-date while in RRC_CONNECTED, the
UE shall:

| | |
|---|---|
| 1> | perform the actions upon leaving RRC_CONNECTED as specified in 5.3.12, with |

```
  release cause ‘other’.
  ------------------------------- TS36.331 V17.3.0 -------------------------------
```

In the most recent standardisation discussion, some agreements have been reached and these are set out below:

### Agreement (RAN1 #109-e)

At least the following options can be considered on GNSS measurement in connected for potential enhancements for improved GNSS operations:
Option 1: UE re-acquires GNSS position fix during RLF procedure
Option 2: UE re-acquires GNSS position fix with a new gap

Note: this does not imply that a Rel-18 IoT NTN UE is mandated to support one or both of the options.

### Agreement (RAN1 #109-e)

Further study on whether there is a need for potential enhancements on the following for long connection time
UE triggered GNSS measurement.
Network triggered GNSS measurement.

Agreement (RAN1 #110-e)

When eNB triggers UE to make GNSS measurements, UE re-acquires GNSS position fix
FFS details of signalling
FFS how UE reports GNSS assistance information after eNB trigger and the detailed content
Note: further discuss whether a UE is expected to handle all eNB triggers
   Agreement (RAN #110b-e)

Support eNB to at least aperiodically trigger UE to make GNSS measurement.

Agreement (RAN #110b-e)

If eNB aperiodically triggers UE to make GNSS measurement, a MAC CE is used.

### Agreement (RAN #111)

For GNSS measurement in RRC connected, if eNB aperiodically triggers connected UE to make GNSS measurement, UE can re-acquire GNSS position fix with a gap
FFS details of gap configuration

The UE may re-acquire GNSS autonomously (when configured by the network) if UE does not receive eNB trigger to make GNSS measurement
FFS based on configured timing

One of the options considered is to introduce measurement gaps where the UE may perform GNSS measurements.

In Rel-18 IoT NTN, 3GPP is working on methods to specify connected mode measurements to allow for longer connection times. These are neighbour cell measurements and GNSS measurements.

Several proposals on how to put conditions on measuring neighbouring cells have been proposed:
Using t-service—The UE thus performs neighbour cell measurements before the satellite will no longer serve the area (this time is given by t-Service)
Using distance-based measurements where a UE will measure and check whether the distance to a serving satellite/NTN node/cell and/or a neighbouring satellite/NTN node/cell fulfills some type of condition.
Using signaling of the coverage of an upcoming NTN cell

To support neighbour cell measurements, it has also been agreed that neighbour cell satellite ephemeris will be provided.

For performing connected mode GNSS measurements, it has been agreed (3GPP RAN1 #111):

For GNSS measurement in RRC connected, if eNB aperiodically triggers connected UE to make GNSS measurement, UE can re-acquire GNSS position fix with a gap
For further study-details of gap configuration

The UE may re-acquire GNSS autonomously (when configured by the network) if UE does not receive eNB trigger to make GNSS measurement
For further study based on configured timing

This means that the UE will perform GNSS measurements in so-called measurement gaps that are configured by the network autonomously. These measurements may be mandatory based on a broadcasted configuration as this is often how devices are configured in NB-IoT networks.

Both neighbour cell measurements and GNSS measurements are likely to be very power-consuming and, in many cases, not needed to be performed for shorter connection times. For instance, for an NB-IoT UE to perform neighbour cell measurements, it is relatively time and power consuming. For an NB-IoT device, according to the requirements [TS36.133, V18.0.0, Requirements for support of radio resource management], to perform neighbour cell measurements in a terrestrial cell may take from 1.5 seconds up to 300 seconds. It should furthermore especially be considered in a Non-terrestrial Network where power consumption is expected to be high, and where time-consuming procedures need to be carefully considered, as the satellites and, by extension, the cells, are moving rather quickly. Power consumption may also be increased in a non-terrestrial network due to the need to acquire ephemeris of neighbouring cells.

As a specific example, if the UE only has a small amount of data to deliver, performing neighbour cell measurements may cause the connection time to be made a lot longer.

Therefore, regardless of the location of network nodes and UEs, there is a need to consider whether neighbour cell measurements should be considered or are needed from a service perspective.

It is an aim of an embodiment of the present invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention, there is provided a method of operating a User Equipment, UE, where the UE is communicatively connectable to a Non-Terrestrial Network, NTN, the method comprising the step of in response to a determination of a predetermined condition, the UE determines whether to acquire or not to acquire System Information from a System Information Block, SIB.

In an embodiment, if the UE determines not to acquire System Information from SIB, it further determines to not make one or more of:
a measurement of a neighbouring cell; and
a Global navigation satellite system, GNSS, measurement.

In an embodiment, the predetermined condition relates to t-service, wherein t-service relates to a time until a satellite does not serve an area where the UE is located and wherein if t-service is within a defined threshold period, then the UE determines to acquire the System Information.

In an embodiment, the predetermined condition relates to a distance-based measurement, where the UE determines if a distance to a satellite or NTN node or cell and/or a neighbouring satellite or NTN node is smaller than a defined threshold distance, and, if so, then the UE determines to acquire the System Information.

In an embodiment, the predetermined condition relates to the UE determining if it is within the coverage of an upcoming NTN cell

In an embodiment, the predefined condition relates to a volume of data traffic to or from the network and if the volume of data traffic is lower than a defined threshold, then the UE determines not to acquire the System Information.

In an embodiment, the predefined condition relates to an amount of data an uplink buffer of the UE and if the volume of data is lower than a defined threshold, then the UE determines not to acquire the System Information.

In an embodiment, the amount of data in the uplink buffer is calculated based on Medium Access Control, MAC, or upper layer, RRC, buffer size, and the determination is based on a threshold which is configured by the network, a threshold that is hard-coded, or a threshold that is determined by UE.

In an embodiment, the predefined condition relates to a volume of data received in a downlink message and the UE is so instructed by the network not to acquire the System Information.

In an embodiment, the predefined condition relates to the UE being configured in short data mode and so the UE determines not to acquire the System Information.

In an embodiment, the predefined condition relates to certain predefined services or data types or if the UE is required to perform or be involved in certain predefined operations and so the UE determines not to acquire the System Information.

According to a second aspect of the present invention, there is provided apparatus arranged to perform the method of the first aspect.

An aspect of this invention is to prevent neighbour cell NTN measurements or GNSS measurements from being performed based on certain conditions.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIG. 1 shows a general NTN architecture known in the prior art;

FIGS. 2a) and 2b) show RLF procedures known in the prior art;

FIGS. 3a) and 3b) show GNSS validity operations known in the prior art;

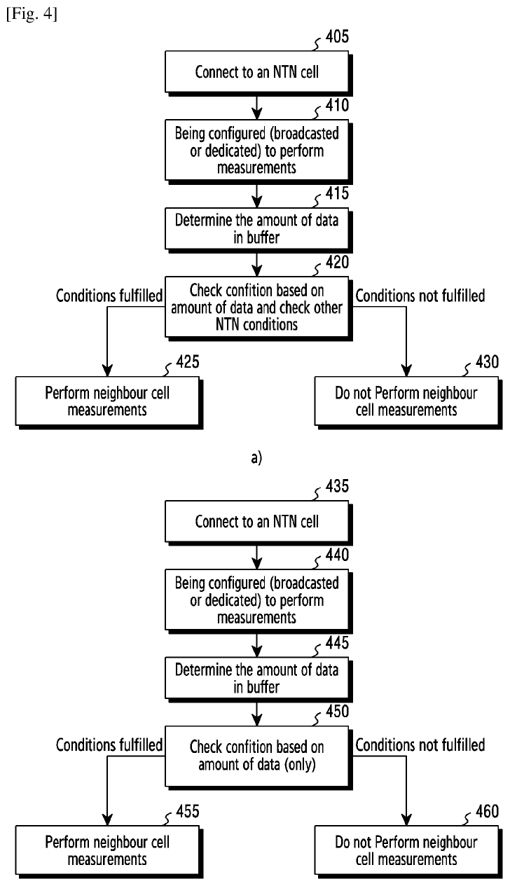

FIGS. 4a) and 4b) show two operations according to embodiments of the invention;

FIG. 5 shows an operation according to an embodiment of the invention; and

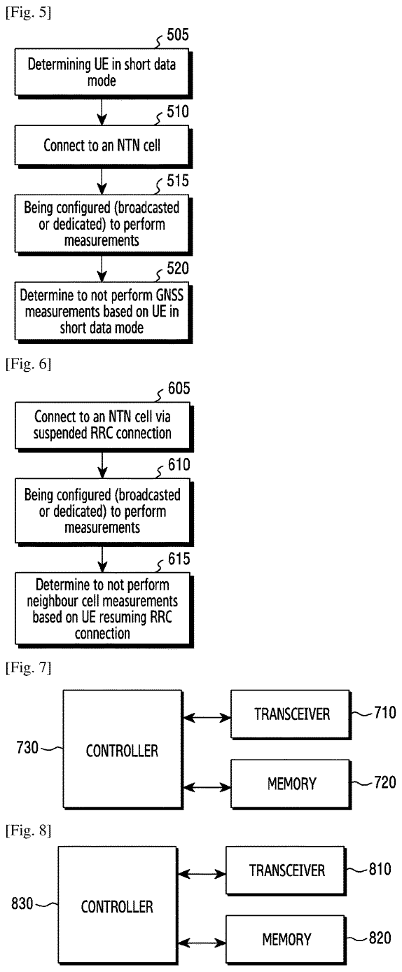

FIG. 6 shows an operation according to an embodiment of the invention;

An embodiment of the invention provides service-based conditions for performing or not performing neighbour cell measurements in a Non-Terrestrial Network.

There may be a number of conditions provided which determine whether to perform neighbour cell measurements or not.

All embodiments set out herein apply to NR NTN or LTE-M/eMTC NTN. Embodiments may also find utility with other systems not referred to explicitly, but which will be know to the skilled person.

In this application, the expression “performing measurements” may also mean “performing measurements, given all other conditions are fulfilled” or “if supported, performing measurements” or “if applicable, performing measurements”, or any other suitable wording. In other words, whether performing measurements may be dependent on other already introduced conditions or independent of already introduced conditions. Wording such as “considering whether to perform neighbour cell measurements” may also be a valid term. In other words, any other conditions for performing measurements such as those given by prior art may still be considered. In some embodiments the conditions are generalized to both GNSS measurements and neighbour cell measurements, and in some conditions only neighbour cell measurements are considered.

In one embodiment, the UE will ignore any conditions to perform neighbour cell measurements or GNSS measurements if the traffic to be delivered by the UE or the network is very low.

In a further embodiment, the UE can detect the amount of data in the uplink buffer and then decides whether to perform any neighbour cell measurements or GNSS measurements. If, for instance, the buffer size is low or very low, then no measurement is performed. This can be determined by a UE in any of the following ways:

The UE calculates the buffer size in Medium Access Control (MAC) or upper layer (RRC buffer size) and determines whether to perform neighbour cell measurements or GNSS measurement. The determination can be performed using a threshold configured by the network, a threshold that is hard-coded, or a threshold that is determined by UE according to some algorithm. The first of these is shown as an example of neighbour cell measurements discussed later and in FIG. 4.

In another embodiment, the UE will ignore any configurations from the network, to perform neighbour cell measurements or GNSS measurements, if the UE determines that the traffic size exchanged between the network and the UE is below a traffic threshold. In one example, the traffic threshold is preconfigured by the network.

In one embodiment, if supported, the UE may postpone performing neighbour cell measurements or GNSS measurements until the UE decides that the traffic size has increased above a predefined threshold.

In a further embodiment, in the case where the data is downlink data delivered by the network, the network can indicate to the UE that there is no need to perform any neighbour cell measurements or GNSS measurements, as the data is rather small. This can be indicated in a number of ways:
In a paging message
In an RRC configuration
   This can also be a flag
In a newly defined RRC procedure, messages and/or IEs.
In a broadcasted message
   This can be a flag that instructs all UEs that are initiated by network for downlink data that there is no need to perform any neighbour cell measurements or GNSS measurements
In a downlink data packet
   This may especially be suitable for an NB-IoT UE where data is delivered over NAS and a flag can be added in an RRC message along with the data. This can be seen later.
Can also be implicit if the UE is utilizing certain procedures:
   For instance, in the case of utilizing RRC Resume and suspend procedure. This means that if the UE is paged and utilizes RRC suspend and resume procedure, the UE does not need to perform neighbour cell measurements or GNSS measurements
   Similarly, if the UE is paged and using Early Data Transmission (EDT) procedure, the UE is not required to perform neighbour cell measurements or GNSS measurements

In one embodiment, the UE is configured with a short data mode, where most of the uplink data is short (i.e. small data size) and thus the UE does not need to perform neighbour cell measurements or GNSS measurements. This can, for instance, be configured by MME or eNB. Alternatively, it can be based on some historic conditions such as previous data packets. For instance, the UE can be configured in such a mode if the data packets of the previous certain number (X) transmissions have been less than a defined threshold, or if the average packet size is smaller than a defined threshold. For example, this short data mode may be configured by a network. An example of this can be seen in FIG. 5.

In one embodiment, if supported, the UE may or may not inform the network of its decision to not perform neighbour cell measurements or GNSS measurements. In one example, the UE may provide to the network a cause value for not performing the configured measurements.

In one embodiment, if supported, the UE ignores neighbouring cell measurements or GNSS measurements for certain services and/or traffic type.

In another embodiment, the UE does not perform neighbour cell measurements or GNSS measurements when the UE needs to perform (or be involved) in specific procedures. For example, these procedures can be tracking area updates (periodic or triggered).

If the UE is configured with suspended RRC connection (also known as resuming RRC connection/RRC Resume procedures/utilizing RRCConnectionResume), the UE may be configured to not consider any neighbour cell measurements or GNSS measurements. For example, this can be configured in a broadcast manner (i.e. via system information broadcast, SIB) or for instance in an RRCConnectionRelease message (and/or using any newly defined RRC signaling/messages and/or IEs). An example of this is described later. This can be beneficial for a UE that is configured with a suspended RRC connection state or mode. This is because the UE is not expected to remain in a RRC connected state or mode for a very long time, and the UE may already have performed measurements in idle mode. An example of this is shown in FIG. 6.

In one embodiment, the UE considers the neighbour cell measurements or GNSS measurements if it has been connected for a period longer than a configured time. For example, this period may be configured by the network.

In a further example, the UE starts a timer, whenever it connects to a cell, and once the configured time has been reached, then the UE considers whether to perform neighbour cell measurements.

In order to measure neighbouring cells in a non-terrestrial network, there may be a need to read or acquire more System Information, compared to not performing any measurements.

Therefore, in one embodiment, if the conditions are fulfilled whereby the UE does not need to perform any neighbour cell measurements, the UE does not need to acquire the related system information for performing the measurements. This system information could, for instance, be neighbouring cell ephemeris, which may or may not be included in a separate System Information Block (SIB). This can save the UE a lot of time and power consumption by not needing to acquire this SIB, as the SIB is also expected to be large since NTN ephemeris is a rather large field.

In one embodiment, the UE does not need to perform neighbour cell measurements or GNSS measurements if Early Data Transmission (EDT) is performed.

There now follows certain illustrative examples to further describe certain embodiments of the invention.

In a first example, the UE will not perform any neighbour cell measurements unless the size of the resulting MAC PDU is larger than a configured threshold, according to the following table 8 and table 9:

TABLE 8
------------------------------TS36.331 V17.3.0 EXAMPLE ----------------------------------
5.5.8 Measurements in NB-IoT
Upon transition to RRC_CONNECTED mode, the UE shall:

| 1> | if neighCellMeasCriteria is present in SystemInformationBlockType3-NB: | |
|---|---|---|
| | 2> | set NRSRPRef to the latest result of the serving cell measurement as used for |

cell selection/reselection evaluation;

| | |
|---|---|
| 2> | if the relaxed monitoring criterion defined in TS 36.304 [4] was not fulfilled or for |

```
  mobile originating calls, if the size of the resulting MAC PDU including total UL data is
  expected to be larger than or equal to the TBS signalled in tbs-NeighCellMeas:
```

| | |
|---|---|
| 3> | start T326 with the value t-MeasureDeltaP; |

While in RRC_CONNECTED mode, after performing a measurement, the UE shall:

| | |
|---|---|
| 1> | in the following use the NRSRP measurement for the measured carrier and nrs- |

PowerOffsetNonAnchor corresponding to the measured carrier;

| 1> | if neighCellMeasCriteria is present in SystemInformationBlockType3-NB: | |
|---|---|---|
| | 2> | if (NRSRPRef − (NRSRP− nrs-PowerOffsetNonAnchor)) > s-MeasureDeltaP: |

| | |
|---|---|
| 3> | set NRSRPRef = (NRSRP − nrs-PowerOffsetNonAnchor); |
| 3> | start or restart T326 with the value t-MeasureDeltaP; |

| 1> | if neighCellMeasCriteria is not present in SystemInformationBlockType3-NB; or | |
|---|---|---|
| 1> | if T326 is running: | |
| | 2> | if (NRSRP − nrs-PowerOffsetNonAnchor) < s-MeasureIntra, perform intra- |

frequency measurements as defined in TS 36.133 [16];

| | |
|---|---|
| 2> | if (NRSRP − nrs-PowerOffsetNonAnchor) < s-MeasureInter, perform inter- |

frequency measurements as defined in TS 36.133 [16].

<...OMITTED...>

TABLE 9
- SystemInformationBlockType3-NB
The IE SystemInformationBlockType3-NB contains cell re-selection information common for intra-
frequency, and inter-frequency cell re-selection as well as intra-frequency cell re-selection information other
than neighbouring cell related.
The following is a representation of SystemInformationBlockType3-NB information element
-- ASN1START

| | |
|---|---|
| SystemInformationBlockType3-NB-r13 ::= | SEQUENCE { |
| cellReselectionInfoCommon-r13 | SEQUENCE { |
| q-Hyst-r13 | ENUMERATED { |
| | dB0, dB1, dB2, B3, dB4, dB5, dB6, dB8, dB10, |
| | dB12, dB14, dB16, dB18, dB20, dB22, dB24 |
| | } |

},

| | |
|---|---|
| cellReselectionServingFreqInfo-r13 | SEQUENCE { |
| s-NonIntraSearch-r13 | ReselectionThreshold |

},

| intraFreqCellReselectionInfo-r13 | SEQUENCE { | |
|---|---|---|
| q-RxLevMin-r13 | Q-RxLevMin, | |
| q-QualMin-r13 | Q-QualMin-r9 | OPTIONAL, -- Need OP |
| p-Max-r13 | P-Max | OPTIONAL, -- Need OP |

| | |
|---|---|
| s-IntraSearchP-r13 | ReselectionThreshold, |
| t-Reselection-r13 | T-Reselection-NB-r13 |

},

| freqBandInfo-r13 | NS-PmaxList-NB-r13 | OPTIONAL, -- Need OR |
|---|---|---|
| multiBandInfoList-r13 | SEQUENCE (SIZE (1..maxMultiBands)) OF | |
| | NS-PmaxList-NB-r13 | OPTIONAL, -- Need OR |
| lateNonCriticalExtension | OCTET STRING | OPTIONAL, |

...,

| | |
|---|---|
| [[ intraFreqCellReselectionInfo-v1350 | IntraFreqCellReselectionInfo-NB-v1350 OPTIONAL |

```
  -- Cond Qrxlevmin
  ]],
```

| | |
|---|---|
| [[ intraFreqCellReselectionInfo-v1360 | IntraFreqCellReselectionInfo-NB-v1360 OPTIONAL |

```
  -- Need OR
  ]],
```

| | |
|---|---|
| [[ intraFreqCellReselectionInfo-v1430 | IntraFreqCellReselectionInfo-NB-v1430 OPTIONAL |

```
  -- Need OR
  ]],
```

| | |
|---|---|
| [[ cellReselectionInfoCommon-v1450 | CellReselectionInfoCommon-NB-v1450 OPTIONAL |

```
  -- Need OR
  ]],
```

| | | |
|---|---|---|
| [[ nsss-RRM-Config-r15 | NSSS-RRM-Config-NB-r15 | OPTIONAL, -- Need OR |
| npbch-RRM-Config-r15 | ENUMERATED {enabled} | OPTIONAL -- Need OR |

]],

| | | |
|---|---|---|
| [[ connMeasConfig-r17 | ConnMeasConfig-NB-r17 | OPTIONAL, -- Need OR |
| t-Service-r17 | TimeOffsetUTC-r17 | OPTIONAL -- Need OR |

]],

| | | |
|---|---|---|
| [[ connMeasConfig-r18 | ConnMeasConfig-NB-r18 | OPTIONAL -- Need OR |

]]
}

| | |
|---|---|
| IntraFreqCellReselectionInfo-NB-v1350 ::= | SEQUENCE { |
| delta-RxLevMin-v1350 | INTEGER (−8..−1) |

}

| | |
|---|---|
| IntraFreqCellReselectionInfo-NB-v1360 ::= | SEQUENCE { |
| s-IntraSearchP-v1360 | ReselectionThreshold-NB-v1360 |

}

| | |
|---|---|
| IntraFreqCellReselectionInfo-NB-v1430 ::= | SEQUENCE { |
| powerClass14dBm-Offset-r14 | ENUMERATED {dB−6, dB−3, dB3, dB6, dB9, dB12} OPTIONAL, -- |

Need OP

| | |
|---|---|
| ce-AuthorisationOffset-r14 | ENUMERATED {dB5, dB10, dB15, dB20, dB25, dB30, dB35} |

OPTIONAL -- Need OP
}

| | |
|---|---|
| CellReselectionInfoCommon-NB-v1450 ::= | SEQUENCE { |
| s-SearchDeltaP-r14 | ENUMERATED {dB6, dB9, dB12, dB15} |

}
ConnMeasConfig-NB-r17 ::= SEQUENCE {

| | |
|---|---|
| s-MeasureIntra-r17 | NRSRP-Range-NB-r14, |
| s-MeasureInter-r17 | NRSRP-Range-NB-r14 OPTIONAL, -- Need OP |
| neighCellMeasCriteria-r17 | SEQUENCE { |
| s-MeasureDeltaP-r17 | ENUMERATED {dB6, dB9, dB12, dB15}, |
| t-MeasureDeltaP-x17 | ENUMERATED {s15, s30, s45 s60} |

} OPTIONAL -- Need OR
}
ConnMeasConfig-NB-r18 ::= SEQUENCE {

| | |
|---|---|
| tbs-NeighCellMeas-r18 | ENUMERATED {true} |

}
-- ASN1STOP
SystemInformationBlockType3-NB field descriptions
ce-AuthorisationOffset
Parameter “Qoffset_{authorization}” in TS 36.304 [4]. Value in dB. Value dB5 corresponds to 5 dB, dB10
corresponds to 10 dB and so on.
If the field is absent, the UE applies the value of ce-authorisationOffset in
SystemInformationBlockType1-NB.
multiBandInfoList
A list of additionalPmax and additionalSpectrumEmission values as defined in TS 36.101 [42], clause
6.2.4F, applicable for the intra-frequency neighbouring NB-IoT cells if the UE selects the frequency
band from freqBandIndicator in SystemInformationBlockType1-NB.
npbch-RRM-Config
For FDD: Configuration for NPBCH-based RRM measurements. See TS 36.214 [24].
If enabled, NPBCH can be used in addition to NRS for RRM measurements for serving cell.
nsss-RRM-Config
For FDD: Configuration for NSSS-based RRM measurements for the serving cell.
powerClass14dBm-Offset
Parameter “Poffset” in TS 36.304 [4], only applicable for UE supporting powerClassNB-14dBm. Value
in dB. Value dB−6 corresponds to −6 dB, dB−3 corresponds to −3 dB and so on. If the field is absent, the
UE applies the (default) value of 0 dB for “Poffset” in TS 36.304 [4].
p-Max
Value applicable for the intra-frequency neighbouring E-UTRA cells. If absent the UE applies the
maximum power according to the UE capability.
q-Hyst
Parameter Q_{hyst} in TS 36.304 [4], Value in dB. Value dB1 corresponds to 1 dB, dB2 corresponds to 2
dB and so on.
q-QualMin
Parameter “Q_{qualmin}” in TS 36.304 [4], applicable for intra-frequency neighbour cells. If the field is not
present, the UE applies the (default) value of negative infinity for Q_{qualmin}.
q-RxLevMin, delta-RxLevMin
Parameter “Qᵣₓₗₑᵥₘᵢₙ” in TS 36.304 [4], applicable for intra-frequency neighbour cells. If delta-RxLevMin
is not included, actual value Qᵣₓₗₑᵥₘᵢₙ = q-RxLevMin * 2 [dBm]. If delta-RxLevMin is included, actual
value Qᵣₓₗₑᵥₘᵢₙ = (q-RxLevMin + delta-RxLevMin) * 2 [dBm].
s-IntraSearchP
Parameter “S_{IntraSearchP}” in TS 36.304 [4].
In case s-IntraSearchP-v1360 is included, the UE shall ignore s-IntraSearchP (i.e. without suffix).
s-MeasureDeltaP
Threshold of change in serving cell NRSRP to trigger neighbour cell measurement in
RRC_CONNECTED state.
s-MeasureInter
NRSRP threshold to trigger inter-frequency neighbour cell measurement in RRC_CONNECTED state.
If the field is absent in connMeasConfig, the UE applies the value of s-MeasureIntra.
s-MeasureIntra
NRSRP threshold to trigger intra-frequency neighbour cell measurement in RRC_CONNECTED state.
s-NonIntraSearch
Parameter “S_{nonIntraSearchP}” in TS 36.304 [4].
s-SearchDeltaP
Parameter “S_{SearchDeltaP}” in TS 36.304 [4]. This parameter is only applicable for UEs supporting relaxed
monitoring as specified in TS 36.306 [5]. Value dB6 corresponds to 6 dB, dB9 corresponds to 9 dB and
so on.
t-MeasureDeltaP
Duration after which the UE is not required to perfom neighbour cell measurement in
RRC_CONNECTED when s-MeasureDeltaP criterion is fulfilled.
t-Reselection
Parameter “Treselection_{NB-IoT}_{_{—}}_{Intra}” in TS 36.304 [4].
t-Service
Time information on when a NTN quasi-Earth fixed cell is going to stop serving the area it is currently
covering.
tbs-NeighCellMeas
Threshold of Transport block size condition to trigger neighbour cell measurements.

In a second example, it is indicated to the UE that it does not need to perform any neighbour cell measurements in a DLInformation-NB message, according to the following table 10:

```
TABLE 10
  ------------------------------ TS36.331 V17.3.0 EXAMPLE ------------------------------
  - DLInformationTransfer-NB
  The DLInformationTransfer-NB message is used for the downlink transfer of NAS dedicated
information.
  Signalling radio bearer: SRB1 or SRB1bis
  RLC-SAP: AM
  Logical channel: DCCH
  Direction: E UTRAN to UE
  The following is a DLInformationTransfer-NB message:
  -- ASN1START
  DLInformationTransfer-NB ::= SEQUENCE {
```

| | |
|---|---|
| rrc-TransactionIdentifier | RRC-TransactionIdentifier, |
| criticalExtensions | CHOICE { |
| c1 | CHOICE { |
| dlInformationTransfer-r13 | DLInformationTransfer-NB-r13-IEs, |

```
        sparel NULL
      },
```

| | |
|---|---|
| criticalExtensionsFuture | SEQUENCE { } |

```
    }
  }
```

| DLInformationTransfer-NB-r13-IEs ::= | SEQUENCE { | |
|---|---|---|
| dedicatedInfoNAS-r13 | DedicatedInfoNAS, | |
| lateNonCriticalExtension | OCTET STRING | OPTIONAL, |
| dlInformationTransfer-18 | DLInformationTransfer-NB-r18-IEs | OPTIONAL |

}

| DLInformationTransfer-NB-r18-IEs ::= | SEQUENCE { | |
|---|---|---|
| neighbourCellMeasurement-r18 | ENUEMRATED {true} | OPTIONAL, |
| lateNonCriticalExtension | OCTET STRING | OPTIONAL, |
| nonCriticalExtension | SEQUENCE { } | OPTIONAL |

```
  }
  -- ASN1STOP
```

In a third example, neighbour cell measurements are not performed if the UE is performing RRC resume, according to the following table 11:

```
TABLE 11
  ------------------------------ 36.331 V17.3.0 EXAMPLE ------------------------------
  5.5.8 Measurements in NB-IoT
  Upon transition to RRC_CONNECTED mode, the UE shall:
```

| 1> | if neighCellMeasCriteria is present in SystemInformationBlockType3-NB: | |
|---|---|---|
| | 2> | set NRSRPRef to the latest result of the serving cell measurement as used for cell |

selection/reselection evaluation;

| | |
|---|---|
| 2> | if the relaxed monitoring criterion defined in TS 36.304 [4] was not fulfilled or if |

neighCellMeasResumeCriteria is true and the UE is not resuming from an RRC suspend state:

| | |
|---|---|
| 3> | start T326 with the value t-MeasureDeltaP; |

While in RRC_CONNECTED mode, after performing a measurement, the UE shall:

| | |
|---|---|
| 1> | in the following use the NRSRP measurement for the measured carrier and nrs- |

PowerOffsetNonAnchor corresponding to the measured carrier;

| 1> | if neighCellMeasCriteria is present in SystemInformationBlockType3-NB: | |
|---|---|---|
| | 2> | if (NRSRPRef − (NRSRP− nrs-PowerOffsetNonAnchor)) > s-MeasureDeltaP: |

| | |
|---|---|
| 3> | set NRSRPRef = (NRSRP − nrs-PowerOffsetNonAnchor); |
| 3> | start or restart T326 with the value t-MeasureDeltaP; |

| 1> | if neighCellMeasCriteria is not present in SystemInformationBlockType3-NB; or | |
|---|---|---|
| 1> | if T326 is running: | |
| | 2> | if (NRSRP − nrs-PowerOffsetNonAnchor) < s-MeasureIntra, perform intra-frequency |

measurements as defined in TS 36.133 [16];

| | |
|---|---|
| 2> | if (NRSRP − nrs-PowerOffsetNonAnchor) < s-MeasureInter, perform inter-frequency |

measurements as defined in TS 36.133 [16].

The corresponding ANSI code is as following table 12:

TABLE 12
SystemInformationBlockType3-NB
The IE SystemInformationBlockType3-NB contains cell re-selection information common for intra-
frequency, and inter-frequency cell re-selection as well as intra-frequency cell re-selection information other
than neighbouring cell related.
The following is the SystemInformationBlockType3-NB information element:
-- ASN1START

| | |
|---|---|
| SystemInformationBlockType3-NB-13 ::= | SEQUENCE { |
| cellReselectionInfoCommon-r13 | SEQUENCE { |
| q-Hyst-r13 | ENUMERATED { |
| | dB0, dB1, dB2, dB3, dB4, dB5, dB6, dB8, dB10, |
| | dB12, dB14, dB26, dB18, dB20, dB22, dB24 |
| | } |

},

| | |
|---|---|
| cellReselectionServingFreqInfo-r13 | SEQUENCE { |
| s-NonIntraSearch-r13 | ReselectionThreshold |

},

| intrafreqCellReselectionInfo-r13 | SEQUENCE { | |
|---|---|---|
| q-RxLevMin-r13 | Q-RxLevMin, | |
| q-QualMin-r13 | Q-QualMin-r9 | OPTIONAL,-- Need OP |
| p-Max-r13 | P-Max | OPTIONAL, -- Need OP |

| | |
|---|---|
| s-IntraSearchP-r13 | ReselectionThreshold, |
| t-Reselection-r13 | T-Reselection-NB-r13 |

},

| freqBandInfo-r13 | NS-PmaxList-NB-r13 | OPTIONAL, -- Need OR |
|---|---|---|
| multiBandInfoList-r13 | SEQUENCE (SIZE (1..maxMultiBands)) OF | |
| | NS-PmaxList-NB-r13 | OPTIONAL, -- Need OR |
| lateNonCriticalExtension | OCTET STRING | OPTIONAL, |

...,

| | |
|---|---|
| [[ intraFreqCellReselectionInfo-v1350 | IntraFreqCellReselectionInfo-NB-v1350 OPTIONAL |

```
  -- Cond Qrxlevmin
  ]],
```

| | |
|---|---|
| [[ intraFreqCellReselectionInfo-v1360 | IntraFreqCellReselectionInfo-NB-v1360 OPTIONAL |

```
  -- Need OR
  ]],
```

| | |
|---|---|
| [[ intraFreqCellReselectionInfo-v1430 | IntraFreqCellReselectionInfo-NB-v1430 OPTIONAL |

```
  -- Need OR
  ]],
```

| | |
|---|---|
| [[ cellReselectionInfoCommon-v1450 | CellReselectionInfoCommon-NB-v1450 OPTIONAL |

```
  -- Need OR
  ]],
```

| | | |
|---|---|---|
| [[ nsss-RRM-Config-r15 | NSSS-RRM-Config-NB-r15 | OPTIONAL, -- Need OR |
| npbch-RRM-Config-r15 | ENUMERATED {enabled} | OPTIONAL -- Need OR |

]],

| | | |
|---|---|---|
| [[ connMeasConfig-r17 | ConnMeasConfig-NB-r17 | OPTIONAL, -- Need OR |
| t-Service-r17 | TimeOffsetUTC-r17 | OPTIONAL -- Need OR |

]],

| | | |
|---|---|---|
| [[ connMeasConfig-r18 | ConnMeasConfig-NB-r18 | OPTIONAL -- Need OR |

]]
}

| | |
|---|---|
| IntraFreqCellReselectionInfo-NB-v1350 ::= | SEQUENCE { |
| delta-RxLevMin-v1350 | INTEGER (−8..−1) |

}

| | |
|---|---|
| IntraFreqCellReselectionInfo-NB-v1360 ::= | SEQUENCE { |
| s-IntraSearchP-v1360 | ReselectionThreshold-NB-v1360 |

}

| | |
|---|---|
| IntraFreqCellReselectionInfo-NB-v1430 ::= | SEQUENCE { |
| powerClass14dBm-Offset-r14 | ENUMERATED {dB−6, dB−3, dB3, dB6, dB9, dB12} OPTIONAL, -- |

Need OP

| | |
|---|---|
| ce-AuthorisationOffset-r14 | ENUMERATED {dB5, d310, dB15, dB20, dB25, dB30, dB35} |

OPTIONAL -- Need OP
}

| | |
|---|---|
| CellReselectionInfoCommon-NB-v1450 ::= | SEQUENCE { |
| s-SearchDeltaP-r14 | ENUMERATED {dB6, dB9, dB12, dB15} |

}
ConnMeasConfig-NB-r17 ::= SEQUENCE {

| | |
|---|---|
| s-MeasureIntra-r17 | NRSRP-Range-NB-r14, |
| s-MeasureInter-r17 | NRSRP-Range-NB-r14 OPTIONAL, -- Need OP |
| neighCellMeasCriteria-r17 | SEQUENCE { |
| s-MeasureDeltaP-r17 | ENUMERATED {dB6, dB9, dB12, dB15}, |
| t-MeasureDeltaP-r17 | ENUMERATED {s15, s30, s45, s60} |

} OPTIONAL -- Need CR
}
ConnMeasConfig-NB-r18 ::= SEQUENCE {

| | | |
|---|---|---|
| neighCellMeasResumeCriteria | ENUMERATED {true} | OPTIONAL, -- Need OP |

}
-- ASN1STOP
SystemInformationBlockType3-NB field descriptions
ce-AuthorisationOffset
Parameter “Qoffset_{authorization}” in TS 36.304 [4]. Value in dB. Value dB5 corresponds to 5 dB, dB10
corresponds to 10 dB and so on.
If the field is absent, UE applies the the value of ce-authorisationOffset in
SystemInformationBlockType1-NB.
multiBandInfoList
A list of additionalPmax and additionalSpectrumEmission values as defined in TS 36.101 [42], clause
6.2.4F, applicable for the intra-frequency neighbouring NB-IoT cells if the UE selects the frequency
band from freqBandIndicator in SystemInformationBlockType1-NB.
neighCellMeasResumeCriteria
Determines whether a UE shall perform neighbour cell measurement after having resumed an RRC
connection.
npbch-RRM-Config
For FDD: Configuration for NPBCH-based RRM measurements. See TS 36.214 [24].
If enabled, NPBCH can be used in addition to NRS for RRM measurements for serving cell.
nsss-RRM-Config
For FDD: Configuration for NSSS-based RRM measurements for the serving cell.
powerClass14dBm-Offset
Parameter “Poffset” in TS 36.304 [4], only applicable for UE supporting powerClassNB-14dBm. Value
in dB. Value dB−6 corresponds to −6 dB, dB−3 corresponds to −3 dB and so on. If the field is absent, the
UE applies the (default) value of 0 dB for “Poffset” in TS 36.304 [4].
p-Max
Value applicable for the intra-frequency neighbouring E-UTRA cells. If absent the UE applies the
maximum power according to the UE capability.
q-Hyst
Parameter Q_{hyst} in TS 36.304 [4], Value in dB. Value dB1 corresponds to 1 dB, dB2 corresponds to 2
dB and so on.
q-QualMin
Parameter “Q_{qualmin}” in TS 36.304 [4], applicable for intra-frequency neighbour cells. If the field is not
present, the UE applies the (default) value of negative infinity for Q_{qualmin}.
q-RxLevMin, delta-RxLevMin
Parameter “Qᵣₓₗₑᵥₘᵢₙ” in TS 36.304 [4], applicable for intra-frequency neighbour cells. If delta-RxLevMin
is not included, actual value Qᵣₓₗₑᵥₘᵢₙ = q-RxLevMin * 2 [dBm]. If delta-RxLevMin is included, actual
value Qᵣₓₗₑᵥₘᵢₙ = (q-RxLevMin + delta-RxLevMin) * 2 [dBm].
s-IntraSearchP
Parameter “S_{IntraSearchP}” in TS 36.304 [4].
In case s-IntraSearchP-v1360 is included, the UE shall ignore s-IntraSearchP (i.e. without suffix).
s-MeasureDeltaP
Threshold of change in serving cell NRSRP to trigger neighbour cell measurement in
RRC_CONNECTED state.
s-MeasureInter
NRSRP threshold to trigger inter-frequency neighbour cell measurement in RRC_CONNECTED state.
If the field is absent in connMeasConfig, the UE applies the value of s-MeasureIntra.
s-MeasureIntra
NRSRP threshold to trigger intra-frequency neighbour cell measurement in RRC_CONNECTED state.
s-NonIntraSearch
Parameter “S_{nonIntraSearchP}” in TS 36.304 [4].
s-SearchDeltaP
Parameter “S_{SearchDeltaP}” in TS 36.304 [4]. This parameter is only applicable for UEs supporting relaxed
monitoring as specified in TS 36.306 [5]. Value dB6 corresponds to 6 dB, dB9 corresponds to 9 dB and
so on.
t-MeasureDeltaP
Duration after which the UE is not required to perfom neighbour cell measurement in
RRC_CONNECTED when s-MeasureDeltaP criterion is fulfilled.
t-Reselection
Parameter “Treselection_{NB-IoT}_{_{—}}_{Intra}” in TS 36.304 [4].
t-Service
Time information on when a NTN quasi-Earth fixed cell is going to stop serving the area it is currently
covering.
tbs-NeighCellMeas
Threshold of Transport block size condition to trigger neighbour cell measurements.

In a fourth example, the UE does not perform GNSS measurements if the buffer is larger than a threshold, according to the following table 13:

```
TABLE 13
  ------------------------------ TS36.331 V17.2.0 EXAMPLE ------------------------------
  5.5.X GNSS measurements for NTN
  The purpose of this procedure is for the UE to perform GNSS measurements in order for the UE to
stay synchronized.
  The UE shall:
```

| | |
|---|---|
| 1> | if gnss-MeasurementGaps is present in SystemInformationBlockType3(-NB) and for mobile |

originating calls, if the size of the resulting MAC PDU including total UL data is expected to be larger than
or equal to the TBS signalled in tbs-NeighCellMeas, if signalled:

| | |
|---|---|
| 2> | perform GNSS measurement in the measurement gap as indicated by gnss- |

MeasurementGaps before the expiry of the GNSS validity duration

FIG. 7 illustrates a block diagram of a terminal (or a user equipment (UE)), according to embodiments of the present disclosure.

As shown in FIG. 7, a terminal according to an embodiment may include a transceiver 710, a memory 720, and a processor (or a controller) 730. The transceiver 710, the memory 720, and the processor (or controller) 730 of the terminal may operate according to a communication method of the terminal described above. However, the components of the terminal are not limited thereto. For example, the terminal may include more or fewer components than those described in FIG. 7. In addition, the processor (or controller) 730, the transceiver 710, and the memory 720 may be implemented as a single chip. Also, the processor (or controller) 730 may include at least one processor.

The transceiver 710 collectively refers to a terminal station receiver and a terminal transmitter, and may transmit/receive a signal to/from a base station or another terminal. The signal transmitted or received to or from the terminal may include control information and data. The transceiver 710 may include a RF transmitter for upconverting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor (or controller) 730, a signal through a wireless channel, and transmit a signal output from the processor (or controller) 730 through the wireless channel.

The memory 720 may store a program and data required for operations of the terminal. Also, the memory 720 may store control information or data included in a signal obtained by the terminal. The memory 720 may be a storage medium, such as read-only memory (ROM), random access memory (RAM), a hard disk, a CD-ROM, and a DVD, or a combination of storage media.

The processor (or controller) 730 may control a series of processes such that the terminal operates as described above. For example, the processor (or controller) 730 may receive a data signal and/or a control signal, and the processor (or controller) 730 may determine a result of receiving the signal transmitted by the base station and/or the other terminal.

FIG. 8 illustrates a block diagram of a base station, according to embodiments of the present disclosure.

As shown in FIG. 8, the base station of the present disclosure may include a transceiver 810, a memory 820, and a processor (or, a controller) 830. The transceiver 810, the memory 820, and the processor (or controller) 830 of the base station may operate according to a communication method of the base station described above. However, the components of the base station are not limited thereto. For example, the base station may include more or fewer components than those described in FIG. 8. In addition, the processor (or controller) 830, the transceiver 810, and the memory 820 may be implemented as a single chip. Also, the processor (or controller) 830 may include at least one processor.

The transceiver 810 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor (or controller) 830, a signal through a wireless channel, and transmit a signal output from the processor (or controller) 830 through the wireless channel.

The memory 820 may store a program and data required for operations of the base station. Also, the memory 820 may store control information or data included in a signal obtained by the base station. The memory 820 may be a storage medium, such as ROM, RAM, a hard disk, a CD-ROM, and a DVD, or a combination of storage media.

The processor (or controller) 830 may control a series of processes such that the base station operates as described above. For example, the processor (or controller) 830 may receive a data signal and/or a control signal, and the processor (or controller) 830 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

For an example, according to an example of the present disclosure, a method of operating a User Equipment, UE, where the UE is communicatively connectable to a Non-Terrestrial Network, NTN, the method comprising the step of in response to a determination of a predetermined condition, the UE determines whether to acquire or not to acquire System Information from a System Information Block, SIB.

For another example, according to an example of the present disclosure, wherein if the UE determines not to acquire System Information from SIB, it further determines to not make one or more of: a measurement of a neighbouring cell; and a Global navigation satellite system, GNSS, measurement.

For another example, according to an example of the present disclosure, wherein the predetermined condition relates to t-service, wherein t-service relates to a time until a satellite does not serve an area where the UE is located and wherein if t-service is within a defined threshold period, then the UE determines to acquire the System Information.

For another example, according to an example of the present disclosure, wherein the predetermined condition relates to a distance-based measurement, where the UE determines if a distance to a satellite or NTN node or cell and/or a neighbouring satellite or NTN node is smaller than a defined threshold distance, and, if so, then the UE determines to acquire the System Information.

For another example, according to an example of the present disclosure, wherein the predetermined condition relates to the UE determining if it is within the coverage of an upcoming NTN cell.

For another example, according to an example of the present disclosure, wherein the predefined condition relates to a volume of data traffic to or from the network and if the volume of data traffic is lower than a defined threshold, then the UE determines not to acquire the System Information.

For another example, according to an example of the present disclosure, wherein the predefined condition relates to an amount of data an uplink buffer of the UE and if the volume of data is lower than a defined threshold, then the UE determines not to acquire the System Information.

For another example, according to an example of the present disclosure, wherein the amount of data in the uplink buffer is calculated based on Medium Access Control, MAC, or upper layer, RRC, buffer size, and the determination is based on a threshold which is configured by the network, a threshold that is hard-coded, or a threshold that is determined by UE.

For another example, according to an example of the present disclosure, wherein the predefined condition relates to a volume of data received in a downlink message and the UE is so instructed by the network not to acquire the System Information.

For another example, according to an example of the present disclosure, wherein the predefined condition relates to the UE being configured in short data mode and so the UE determines not to acquire the System Information.

For another example, according to an example of the present disclosure, wherein the predefined condition relates to certain predefined services or data types or if the UE is required to perform or be involved in certain predefined operations and so the UE determines not to acquire the System Information.

For another example, according to an example of the present disclosure, an apparatus arranged to perform the above described methods are provided.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a terminal in a communication system, the method comprising:
receiving, from a base station, at least one of time information on when a non-terrestrial network (NTN) cell is going to stop serving an area, or threshold information on a distance from a reference location; and
identifying whether to perform a measurement, based on at least one of the time information or the distance threshold information.

2. The method of claim 1, wherein, in case that at least one of a first condition based on the time information or a second condition based on the threshold information is met, the measurement is performed.

3. The method of claim 2, wherein the first condition is met, before a time instance corresponding to the time information.

4. The method of claim 2, wherein the second condition is met, in case that a distance between the terminal and the reference location is above a threshold corresponding to the threshold information.

5. The method of claim 1, further comprising:
receiving a system information block (SIB) associated with satellite information for a neighbour cell.

6. The method of claim 1, wherein, in case that a first condition based on the time information and a second condition based on the threshold information are not met, the measurement is not performed.

7. The method of claim 1, further comprising:
identifying whether to perform a global navigation satellite system (GNSS) measurement, based on at least one of the time information or the threshold information,
wherein the GNSS measurement is performed in a radio resource control (RRC) connected state.

8. A terminal in a communication system, the terminal comprising:
a transceiver; and
a controller coupled with the transceiver and configured to:
receive, from a base station, at least one of time information on when a non-terrestrial network (NTN) cell is going to stop serving an area, or threshold information on a distance from a reference location, and
identify whether to perform a measurement, based on at least one of the time information or the distance threshold information.

9. The terminal of claim 8, wherein, in case that at least one of a first condition based on the time information or a second condition based on the threshold information is met, the measurement is performed.

10. The terminal of claim 9, wherein the first condition is met, before a time instance corresponding to the time information.

11. The terminal of claim 9, wherein the second condition is met, in case that a distance between the terminal and the reference location is above a threshold corresponding to the threshold information.

12. The terminal of claim 8, wherein the controller is further configured to:
receive a system information block (SIB) associated with satellite information for a neighbour cell.

13. The terminal of claim 8, wherein, in case that a first condition based on the time information and a second condition based on the threshold information are not met, the measurement is not performed.

14. The terminal of claim 8, wherein the controller is further configured to:
identify whether to perform a global navigation satellite system (GNSS) measurement, based on at least one of the time information or the threshold information.

15. The terminal of claim 14, wherein the GNSS measurement is performed in a radio resource control (RRC) connected state.
